(19) United States
(12) Patent Application Publication
(10) Pub. No.: US 2026/0199939 A1
(43) Pub. Date: Jul. 16, 2026

(54) CLEANING APPARATUS

(71) Applicants: Zachary Reeves, Wellton, AZ (US); Rebecca Reeves, Wellton, AZ (US)

(72) Inventors: Zachary Reeves, Wellton, AZ (US); Rebecca Reeves, Wellton, AZ (US)

(21) Appl. No.: 19/292,881

(22) Filed: Aug. 6, 2025

Related U.S. Application Data
(60) Provisional application No. 63/679,658, filed on Aug. 6, 2024.

(51) Int. Cl. B08B 9/087

(52) U.S. Cl. CPC B08B 9/087; B08B 2209/08

(57) ABSTRACT

A cleaning apparatus includes a plastic reservoir base container assembly configured to hold a volume of food safe cleaning solution, a valve disposed above the reservoir base container assembly and configured to dispense the food safe cleaning solution from the reservoir base container assembly when the reservoir base container assembly is squeezed, a cleaning pad assembly configured to receive the food safe cleaning solution from the valve, and a cover assembly configured to cover the cleaning pad assembly.

This application claims priority to U.S. provisional application having Ser. No. 63/679,658, and a filing date of August 6, 2025, which is hereby incorporated by reference.

### TECHNICAL FIELD

Example embodiments disclosed herein relate generally to a cleaning apparatus, and more specifically to a cleaning apparatus configured to clean the outside of beverage or food containers.

### SUMMARY

A brief summary of various example embodiments is presented below. Some simplifications and omissions may be made in the following summary, which is intended to highlight and introduce some aspects of the various example embodiments, but not to limit the scope of the invention. Detailed descriptions of example embodiments adequate to allow those of ordinary skill in the art to make and use the inventive concepts will follow in later sections.

Embodiments include a cleaning apparatus, including a reservoir base container assembly configured to hold a volume of food safe cleaning solution, a valve disposed above the reservoir base container assembly and configured to dispense the food safe cleaning solution from the reservoir base container assembly when the reservoir base container assembly is squeezed, a cleaning pad assembly configured to receive the food safe cleaning solution from the valve, and a cover assembly configured to cover the cleaning pad assembly.

A plurality of latches may be configured to fasten the cleaning apparatus together.

The plurality of latches may include a first latch configured to connect the cover assembly to the reservoir base container assembly.

The plurality of latches may include a curved latch within the cover assembly.

The plurality of latches may include a sponge ridge within the cleaning pad assembly.

Embodiments also include a cleaning apparatus including a foam assembly configured to receive a food grade cleaning solution from a reservoir base container, a housing covering the foam assembly, the housing configured to be opened and closed, wherein the housing includes a sponge assembly and a vented lid to cover the sponge assembly.

The housing may include a hinged lid and wherein the vented lid includes a curved latch that is configured to connect to the hinged lid.

The foam assembly may include a foam cleaning pad having a plurality of ridges.

Embodiments may also include a method of using a cleaning apparatus, including opening a housing that includes a second sponge assembly to reveal a first sponge assembly, wherein the first sponge assembly is configured to receive an amount of food grade cleaning solution from a reservoir base container, squeezing the reservoir base container to load an amount of the food grade cleaning solution into the first sponge assembly, using the first sponge assembly to clean a beverage or food item, opening a vented lid in the housing to expose the second sponge assembly; and wiping a surface of the beverage or food item with the second sponge assembly.

### BRIEF DESCRIPTION OF THE DRAWINGS

Additional objects and features of the invention will be more readily apparent from the following detailed description and appended claims when taken in conjunction with the drawings. Although several example embodiments are illustrated and described, like reference numerals identify like parts in each of the figures, in which:

FIGS. 1 and 2 illustrate a cleaning apparatus in accordance with embodiments described herein;

FIG. 3 illustrates an exploded view of a cleaning apparatus in accordance with FIG. 1;

FIG. 4 illustrates an example use case of a cleaning apparatus.

FIGS. 5 and 6 illustrate variations of a one-way valve that may be used in combination with a cleaning pad in accordance with embodiments described herein; and

FIG. 7 illustrates another embodiment of the cleaning apparatus with a twist-on cleaning pad in accordance with embodiments described herein.

### DETAILED DESCRIPTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various example embodiments described herein are not necessarily mutually exclusive, as some example embodiments can be combined with one or more other example embodiments to form new example embodiments. Descriptors such as “first,” “second,” “third,” etc., are not meant to limit the order of elements discussed, are used to distinguish one element from the next, and are generally interchangeable. Values such as maximum or minimum may be predetermined and set to different values based on the application.

Debris like dirt, germs, and bacteria can accumulate on various store-bought food items such as beverage cans, candy wrappers, drink bottles, and the like during storage and prior to them being sold. Also, when exercising or working in outdoor environments, drink containers and food wrappers can become contaminated with dirt or debris from people’s hands or the environment. When opening a food wrapper or a drink container, people often want to clean the drinking spout on a can or other beverage container prior to consumption and end up swallowing harmful particulates. Illnesses can be easily spread if people drink from unclean cans or do not clean the outside of food wrappers or other beverage containers before consuming the food or drink inside. Thus there is a desire to have an apparatus configured to allow a user to clean dirt or other contaminants from a beverage container or the like before consuming the food or drink contained therein.

Embodiments described herein provide an apparatus to enable users to use a hand-held tool to clean and disinfect beverage can surfaces and the like.

The cleaning apparatus described herein includes a foam head atop a container that is filled with a cleaning liquid that can be squeezed to saturate the foam head and provide a cleaning solution that can be used to clean surfaces.

The foam or sponge head is detachable from the cleaning apparatus and can be cleaned or replaced as needed to maintain the cleaning apparatus ready for use.

Embodiments described herein offer a multi-faceted apparatus configured provide a cleaning solution that will allow beverage cans and other food and beverage container to be cleaned before consuming the contents therein. The beverage and food containers will therefore be safe to drink from without users having to worry about the spreading or consuming of harmful germs or bacteria that could lead to severe illnesses.

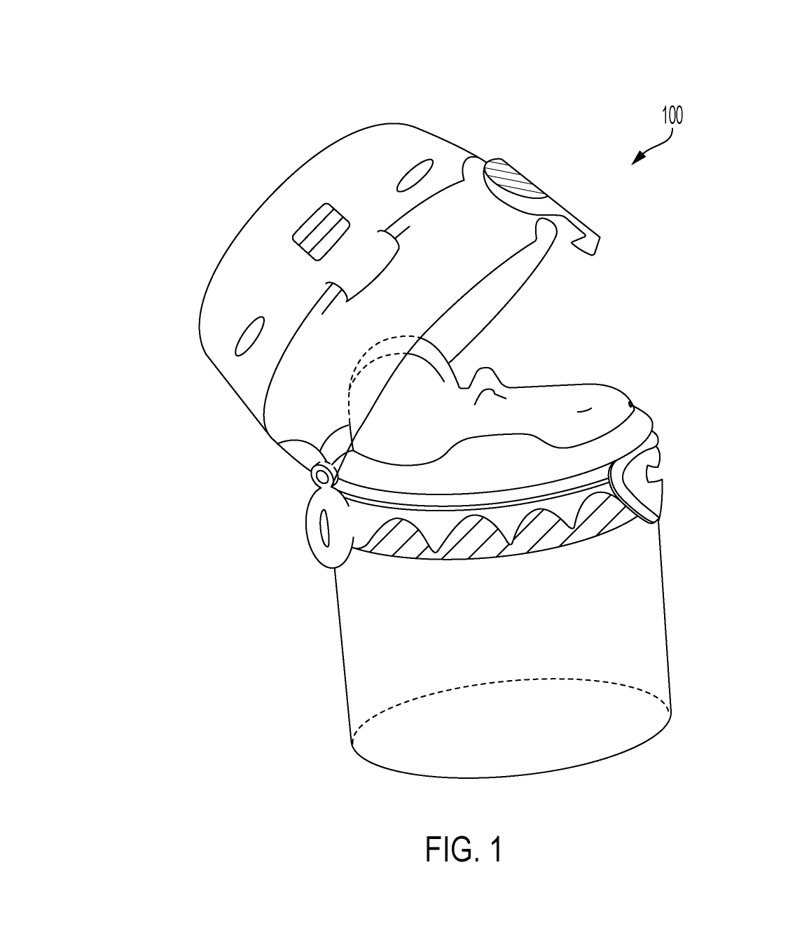

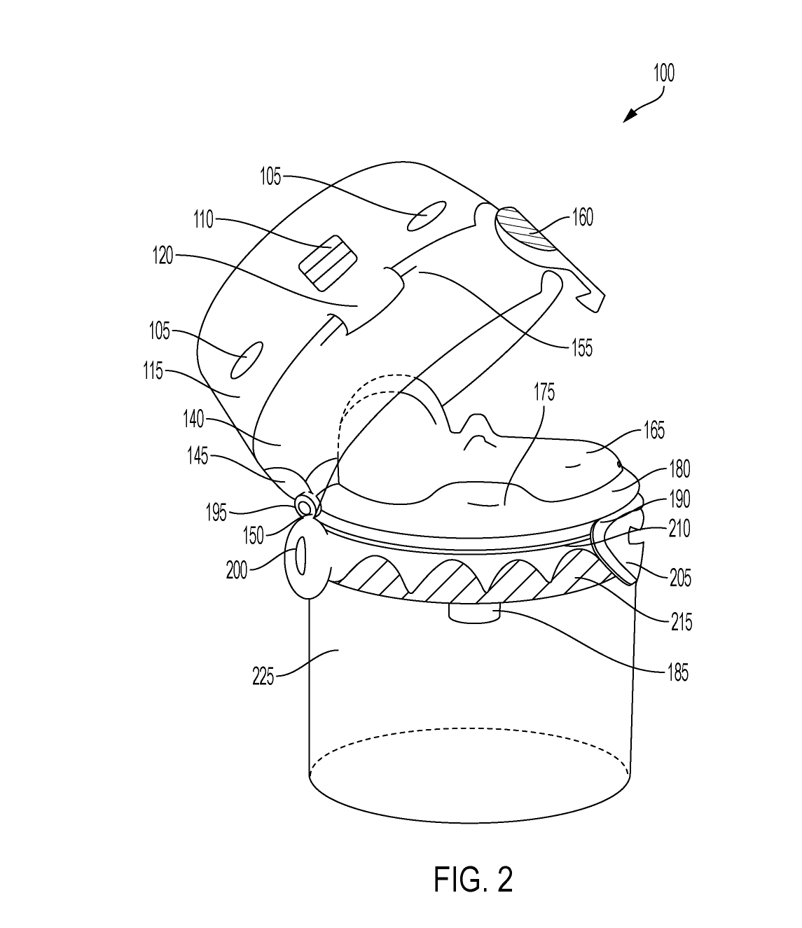

FIGS. 1 and 2 illustrate a cleaning apparatus 100 in accordance with embodiments described herein.

As illustrated in FIG. 2, the cleaning apparatus 100 includes a squeezable plastic reservoir base container 135. The reservoir base container 135 is configured to store and hold a volume of food grade cleaning liquid 137. The food grade cleaning liquid may include three percent (3%) food-grade hydrogen peroxide, thereabouts, or lower. These grade hydrogen peroxides are safe for use on surfaces that touch food, including soda can lids and the like. When used, the food grade cleaning liquid 137 may be allowed to sit briefly, for about a minute, on a surface and air-dry or be wiped clean with the second sponge described herein. If hydrogen peroxide is used for the food grade cleaning liquid 137, the hydrogen peroxide should be free of stabilizers and additives that are often found in drugstore versions.

The reservoir base container 135 is made of a flexible yet sturdy plastic that is configured to be squeezed by a user. The reservoir base container 135 includes a tube 138 disposed therein that is configured to receive the food grade cleaning liquid 137 when the reservoir base container 135 is squeezed. At one end of the tube 138 is a one-way valve 185 that is configured to pass the food grade cleaning liquid 137 in one direction from the reservoir base container 135 to a sponge assembly. A second end of the tube 138 is open to receive the food grade cleaning liquid 137 from near the bottom of the reservoir base container 135.

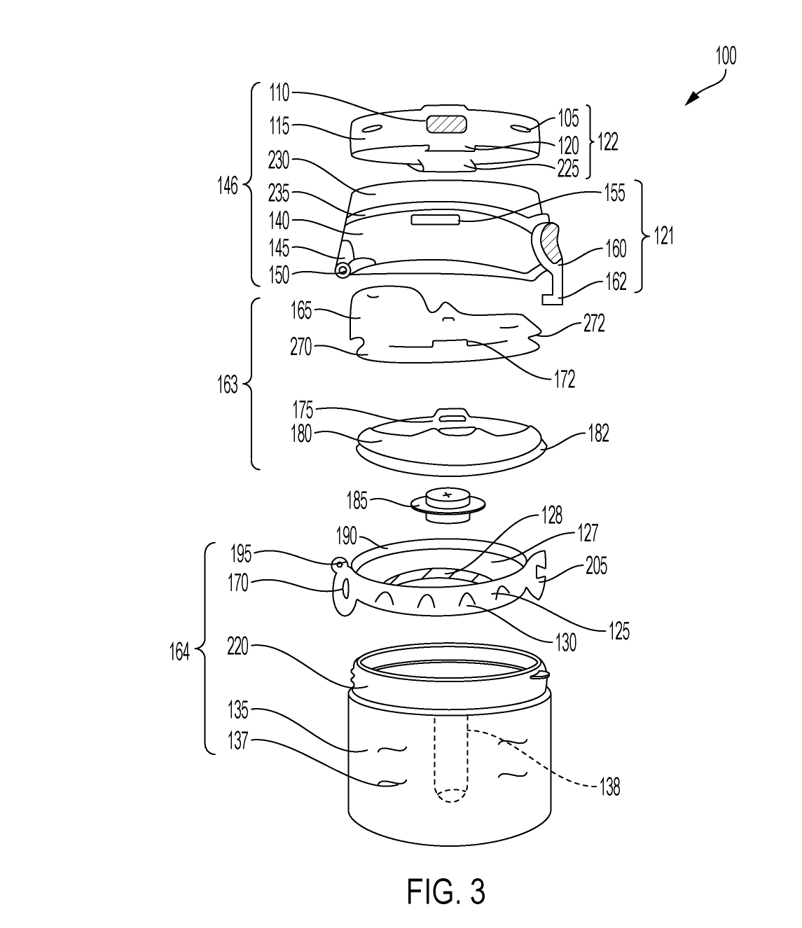

Above the reservoir base container 135 and surrounding the one-way valve 185 is a screw-on lid 125. The screw-on lid 125 provides structure for the cleaning apparatus 100. The structure of the screw-on lid 125 allows a housing to be connected thereto. The screw-on lid includes a hinge cap 195 that is one end of a hinge structure. The hinge structure (illustrated in FIG. 3) is configured to allow a housing 146 to be opened and closed to expose a cleaning pad assembly 163. The cleaning pad assembly 163 includes a cleaning pad 165. As described herein in various embodiments, the one-way valve sometimes may be a part of the cleaning pad assembly 163 and sometimes may be a part of the base reservoir assembly 164.

The screw-on lid 125 includes several components of the cleaning apparatus 100. On one side of the screw-on lid 125 is a latch receiver 192. The latch receiver 192 is configured to receive a latch and close the cleaning apparatus 100 when not in use. Substantially opposite the latch receiver 192 is disposed a hook 170. The hook 170 is a plastic or metal protrusion formed on an external edge of the screw-on lid 125. The hook 170 has a hole therein to receive an attachment such as keychain, rope, or the like (not illustrated) such that a user can carry the cleaning apparatus 100. The screw-on lid 125 may also have indentations 130. The indentations 130 are ridged or raised areas that may provide a tactile gripping surface for a user to install or remove the screw-on lid 125. An upper surface of the screw-on lid 125 is a ridge portion 190. The ridge portion 190 extends inward so as to receive and hold a grooved portion (illustrated in FIG. 3) of the cleaning pad 165. Extending from the ridge portion 190 may be barrier regions 131 that border the indentations 130 and are configured to provide additional gripping surface for a user to screw on or screw off the screw-on lid 125. The screw-on lid 125 combined with the base reservoir container 135 may be referred to as a reservoir base container assembly 164.

The housing 146 includes a lower portion 121 and an upper portion 122. The lower portion 121 includes a lid 140. The lid 140 connects to a hinge (illustrated in FIG. 3) that allows the housing 146 to be raised and lowered to expose the cleaning pad 165. The lower portion 121 of the housing includes a middle groove 155 that protrudes from the lower portion 121. The upper portion 122 of the housing 146 includes a curved latch 120 that fastens to the middle groove 155 via another hinge component (illustrated in FIG. 3). The upper portion 122 is configured to open and close to expose a second pad assembly that is part of the lower portion 121 (illustrated in FIG. 3).

The upper portion 122 of the housing 146 includes ventilation holes 105 to allow a second sponge of the second sponge assembly to dry. The upper portion 122 also includes a finger placement button 110. The finger placement button 110 may be pushed to lever out the curved latch 120 to separate the upper portion 122 from the lower portion 121.

Above the screw-on lid 125 is disposed the cleaning pad assembly 163. The cleaning pad assembly 163 includes a base piece 180 that is configured to hold the cleaning pad 165. The base piece 180 includes a catch 175 that is configured to receive a ridge 172 on the cleaning pad 165 to hold the cleaning pad 165 in place (illustrated in FIG. 3). The cleaning pad assembly 163 may also be referred to as a first pad assembly.

On top of the base piece is the cleaning pad 165. The cleaning pad 165 may be made out of various materials, such as a sponge or foam. The cleaning pad 165 may be a foam cleaning pad, such as an open-cell polyurethane foam or other sponge-like material suitable for absorbing and releasing liquid. The cleaning pad 165 is configured to fit snugly into the base piece 180 of the cleaning pad assembly 163 so that the when the cleaning apparatus 100 is held in various positions and applied to a beverage can, bottle, food item , or the like, such as upside down, the cleaning pad 165 will not fall out of the cleaning apparatus 100.

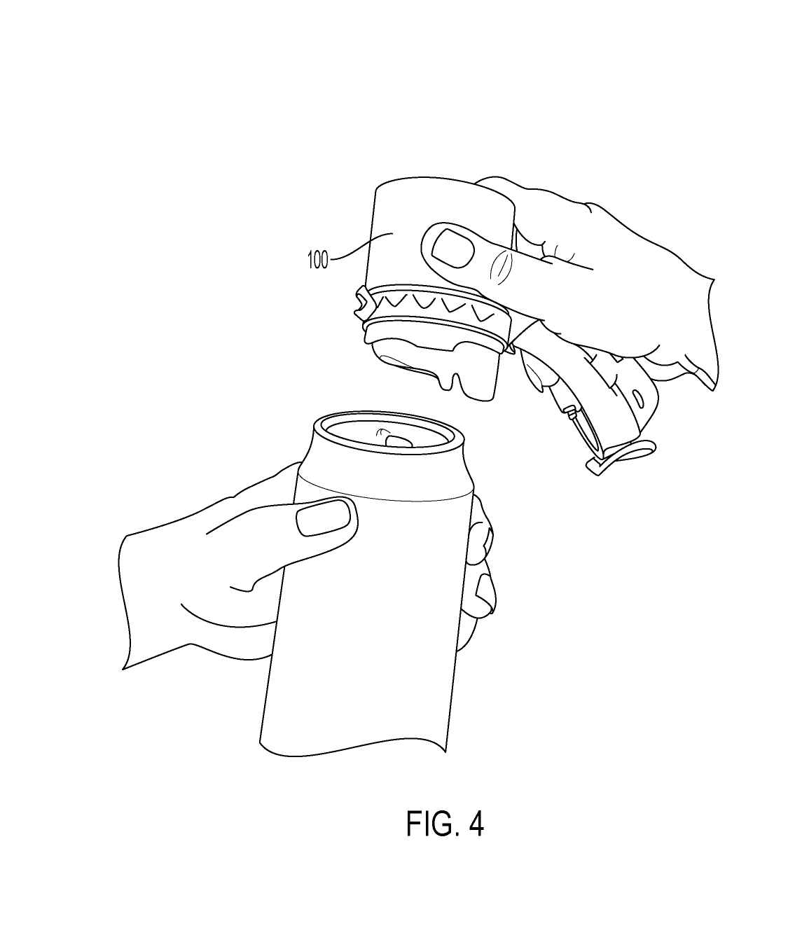

As illustrated, the cleaning pad 165 may have a plurality of ridges and a cavity. A cavity 171 is disposed between a small ridge 171a and a large ridge 171b. After the cleaning pad 165 has been sufficiently saturated with the food grade cleaning liquid 137, the cavity may be positioned on a lip of a beverage can or the like. The small ridge 171a, the cavity 171, and the large ridge 171b may then work in unison to clean a top, lip, and side of a beverage can according to embodiments described herein, and as illustrated in FIG. 4, for example.

As discussed herein, the housing 146 is configured to be opened and closed to expose the cleaning pad 165. The lower portion 121 of the housing 146 includes a latch 160 connected a side thereof. The latch 160 includes a latch hook 162 configured to fasten to the latch receiver 192 described herein.

FIG. 3 illustrates an exploded view of a cleaning apparatus in accordance with FIGS. 1 and 2. As illustrated in FIG. 3, an upper portion of the reservoir base container 135 may be threaded, and have threads 220. Thus the screw-on lid 125 having internal threads may be screwed onto the reservoir base container 135. The screw-on lid 125 has an internal curved structure 127 that has an opening 128 configured to receive the one-way valve 185. The one-way valves may have various configurations as described herein, and features are not limited thereto. When the reservoir base container 135 is squeezed, food grade cleaning liquid 137 that is stored therein will pass into the tube 138 at a bottom section thereof, through the tube 138, and out of the one-way valve 185, the tube 138 being connected to the one-way valve 185.

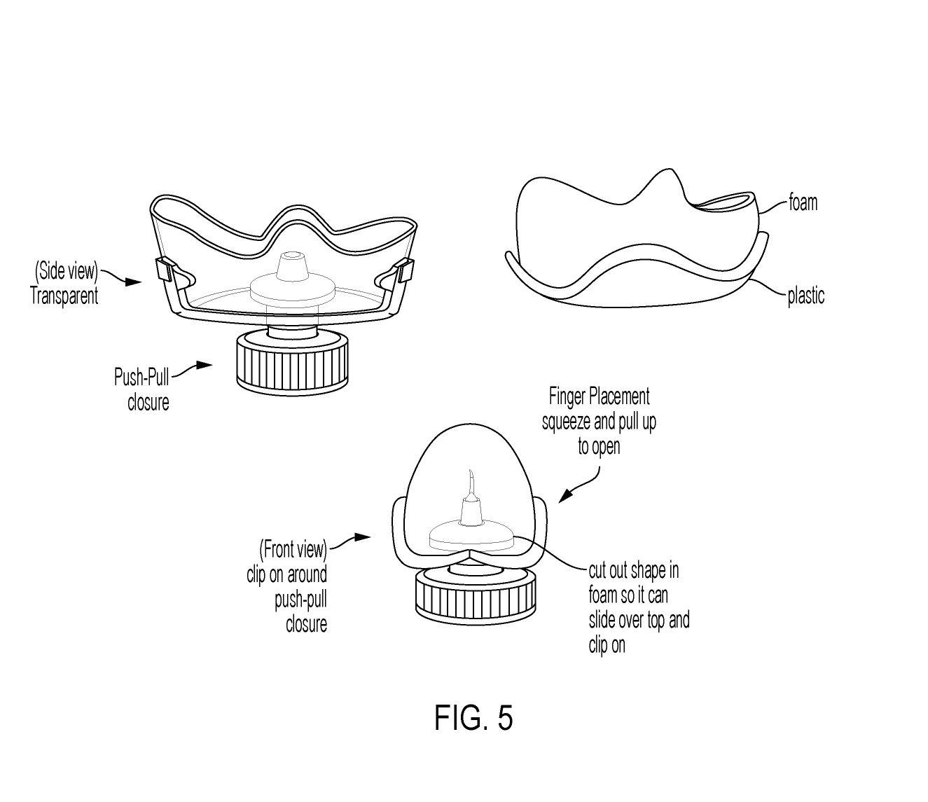

The one-way valve 185 may have various configurations. For example, as illustrated in FIG. 5, the one-way valve 185 may have a push-pull enclosure. There may be a clip surrounding the push-pull enclosure, such that a user’s fingers may be used to squeeze a nozzle and pull-up to open. There may be a cut-out shape in the cleaning pad 165 such that the cleaning pad 165 can slide over a top of a push-pull nozzle and clip on.

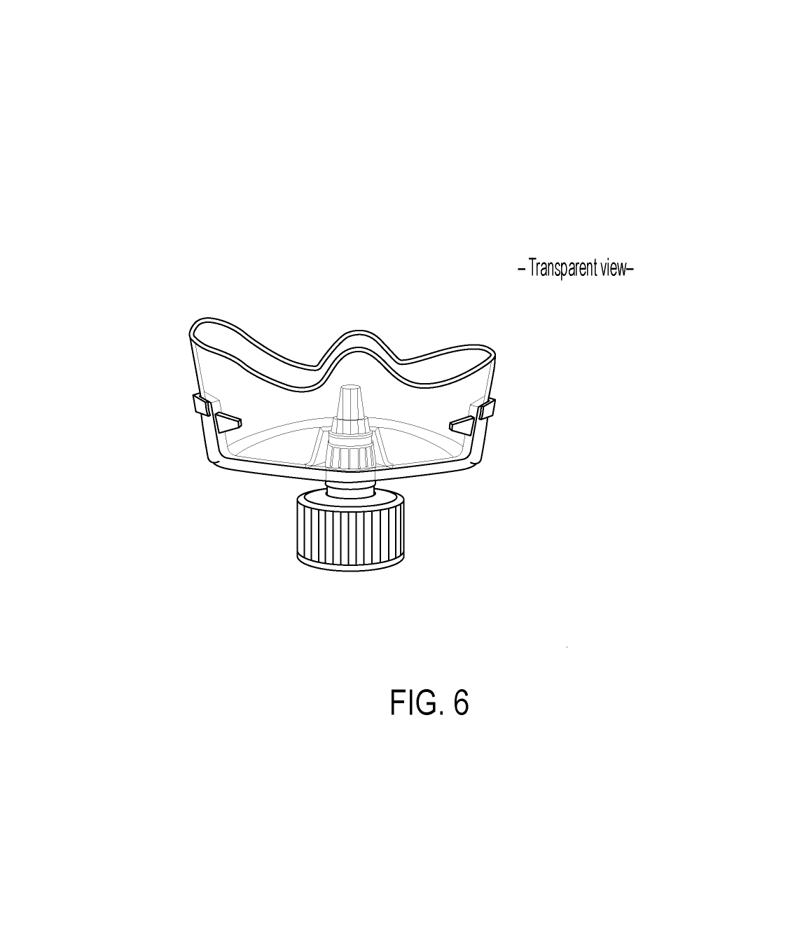

Another embodiment, as illustrated in FIG. 6, hard plastic clips or slides onto and a user may twist to open a ribbed dispensing lid. A user may again squeeze ends to lift and remove a head of a nozzle. The cleaning pad 165 may be permanently or temporarily attached to twist or pull the top. When the cleaning pad 165 is permanently attached to a top of the nozzle, the top and the cleaning pad 165 may be replaced together. Alternatively the cleaning pad 165 may be removed and put into a clip and held and/or small Velcro® adhesive used.

Above the one-way valve 185 is disposed the cleaning pad assembly 163. The cleaning pad assembly 163 includes a flange 182 to connect to the ridge 190 of the screw-on lid 125. Connected to the flange 182 is a base piece 180 configured to hold the cleaning pad 165. The cleaning pad includes a groove 272 that extends around the cleaning pad 165 and a jutting portion 270 that juts out under the groove 272 around the cleaning pad 165. The groove 272 and jutting portion 270 allow the cleaning pad 165 to fit snugly into the base piece 180. This snug fit is a feature of the cleaning apparatus 100 such that when the cleaning pad 165 is applied to the surface of a beverage can, food wrapper, or the like, the cleaning pad will provide a firm surface that is able to clear away dirt and debris. In addition to the groove 272 and jutting portion 270, the cleaning pad also may have a foam ridge 172 that is configured to latch onto the catch 175 disposed on the base piece 180. These features also contribute to the snug fit of the cleaning pad 165 in the cleaning apparatus 100.

After a beverage can or desired article has been moistened and cleaned by the cleaning pad 165, the cleaning apparatus 100 as provided herein includes an additional drying pad 230. The drying pad may also be a foam or sponge material as described herein. Unlike the cleaning pad 165, the drying pad 230 does not receive liquid from the base container reservoir 135. The drying pad 230 rests in a circular ring 235 that holds the drying pad 230. The circular ring 235 is disposed on the hinged lid 140. The drying pad 230 is disposed in the lower portion 121 of the housing 146.

The upper portion 122 of the housing 146 may be lifted at a rear hinge 225 on the upper portion 122 to expose the drying pad 230. The drying pad 230 is exposed so that a user may wipe excess moisture or debris from a beverage can, other beverage, or article of food. Thus a user may use both the cleaning pad 165 and drying pad 230 in tandem when cleaning a beverage. Alternatively, a user may use only the cleaning pad 165 if the user believes a surface may air dry without the use of the drying pad 230.

Thus the cleaning apparatus 100 includes a plurality of hinge features including the rear hinge 225 that lifts the top portion 122 of the housing 146. The plurality of hinge features also includes a hinge pin 150 and hinges 145 that are configured to allow the housing 146 to be opened and closed. When the cleaning apparatus 100 is assembled, the hinge pin 150 is met by the hinge cap 195 so that the housing 146 may rotate with respect to the reservoir base container assembly 164.

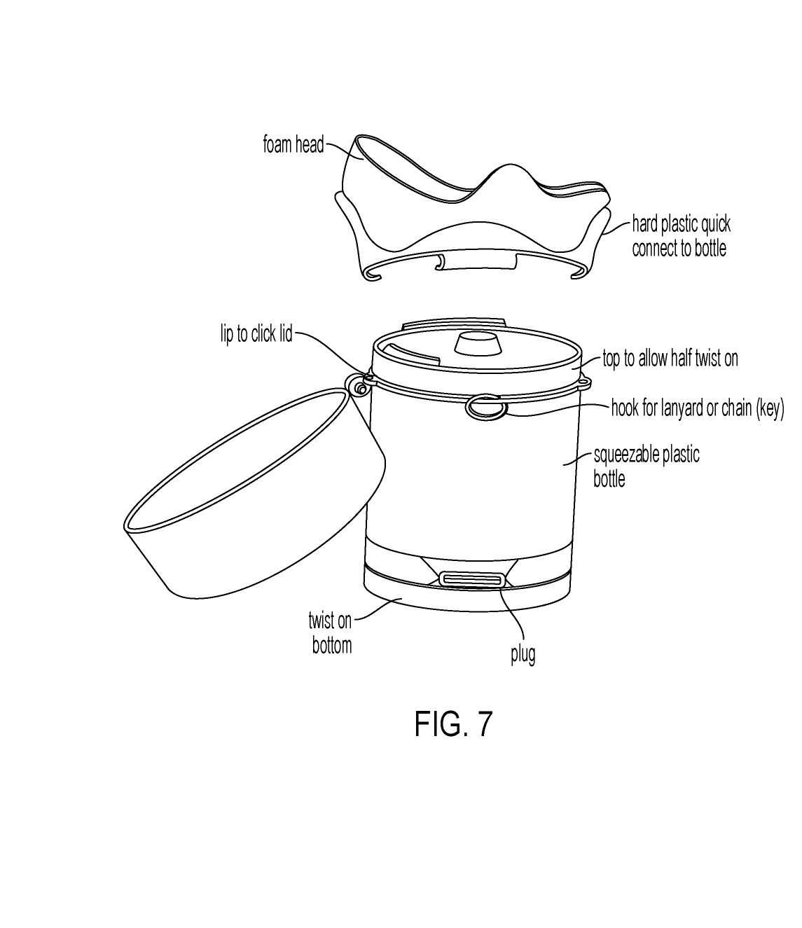

FIG. 7 includes an alternative embodiment where the cleaning pad 165 may be connected to a hard plastic and provide a quick connect that may connect to the reservoir base container 135 or a variation of a reservoir base container assembly 164a. A reservoir base container assembly 164a may have a top that allows the combination cleaning pad 165 and hard plastic base to be installed and uninstalled by half-twist. FIG. 7 also illustrates a plug and twist action on a bottom of the reservoir base container assembly 164a where the food grade cleaning fluid 137 may be loaded into a bottom of the container. Thus a reservoir base container may be tilted on its side and the food grade cleaning fluid 137 may be entered in.

The cleaning apparatus described herein is a cleaning device configured to clean the drinking area of beverage cans and the like. The device is comprised of a container with a foam head, and an opening opposite the foam head. The container would be filled with an antimicrobial food grade cleaning liquid that would be used to sanitize the surface of the can.

As described herein, using the cleaning apparatus 100, a user would be able to squeeze the reservoir base container 135, which would push a small amount of the food grade cleaning fluid through the cleaning pad 165. The user would then use the cleaning pad 165 to clean the surface of a can or other apparatus creating a clean surface from which to drink or eat. The cleaning apparatus 100 may also include a replaceable cleaning pad 165, attachment parts to allow the cleaning apparatus 100 to connect to a key chain or other carrying mechanism. The cleaning apparatus 100 is multi-use and may be refilled. When empty, users would be able to refill the reservoir base container 135 from either end thereof.

Although the various exemplary embodiments have been described in detail with particular reference to certain exemplary aspects thereof, it should be understood that the invention is capable of other example embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

1. A cleaning apparatus, comprising:
a reservoir base container assembly configured to hold a volume of food safe cleaning solution;
a valve disposed above the reservoir base container assembly and configured to dispense the food safe cleaning solution from the reservoir base container assembly when the reservoir base container assembly is squeezed;
a cleaning pad assembly configured to receive the food safe cleaning solution from the valve; and
a cover assembly configured to cover the cleaning pad assembly.

2. The cleaning apparatus of claim 1, comprising:
a plurality of latches configured to fasten the cleaning apparatus together.

3. The cleaning apparatus of claim 2, wherein the plurality of latches includes a first latch configured to connect the cover assembly to the reservoir base container assembly.

4. The cleaning apparatus of claim 2, wherein the plurality of latches includes a curved latch within the cover assembly.

5. The cleaning apparatus of claim 2, wherein the plurality of latches includes a sponge ridge within the cleaning pad assembly.

6. A cleaning apparatus, comprising:
a foam assembly configured to receive a food grade cleaning solution from a reservoir base container;
a housing covering the foam assembly, the housing configured to be opened and closed, wherein the housing includes a sponge assembly and a vented lid to cover the sponge assembly.

7. The cleaning apparatus of claim 6, wherein the housing includes:
a hinged lid; and
wherein the vented lid includes a curved latch that is configured to connect to the hinged lid.

8. The cleaning apparatus of claim 6, wherein the foam assembly includes a foam cleaning pad having a plurality of ridges.

9. A method of using a cleaning apparatus, comprising:
opening a housing that includes a second sponge assembly to reveal a first sponge assembly, wherein the first sponge assembly is configured to receive an amount of food grade cleaning solution from a reservoir base container;
squeezing the reservoir base container to load an amount of the food grade cleaning solution into the first sponge assembly;
using the first sponge assembly to clean a beverage or food item;
opening a vented lid in the housing to expose the second sponge assembly; and
wiping a surface of the beverage or food item with the second sponge assembly.
